(19) United States
(12) Patent Application Publication
(10) Pub. No.: US 2019/0291208 A1
(43) Pub. Date: Sep. 26, 2019

(54) FIBER LASER-BASE PIPELINE COUPLING SYSTEM AND METHOD OF INSTALLATION OF PIPE SEGMENTS

(71) Applicant: IPG PHOTONICS CORPORATION, Oxford, MA (US)

(72) Inventors: Andrey USHAKOV, Oxford, MA (US); Nikolay GREZEV, Oxford, MA (US); Valentin GAPONTSEV, Oxford, MA (US)

(21) Appl. No.: 16/348,785

(22) PCT Filed: Nov. 13, 2017
(86) PCT No.: PCT/US2017/061235

§ 371 Date: May 9, 2019

Related U.S. Application Data
(60) Provisional application No. 62/424,129, filed on Nov. 18, 2016.
(60) Provisional application No. 62/436,798, filed on Dec. 20, 2016.

(51) Int. Cl. B23K 26/30; B23K 33/00; F16L 1/036; F16L 13/02

(52) U.S. Cl. CPC B23K 26/30; B23K 33/006; B23K 2101/10; F16L 13/02; F16L 1/036

(57) ABSTRACT

The disclosed laser-based method for pipeline installation includes of forming coronal formations on opposite wall ends of each pipe, continuously interengaging the corona formations of adjacent pipelines and welding a joint between the corona formations unto the desired pipeline length is reached. In particular, the disclosure relates to a pipe connection system including recessed wall ends of respective adjacent pipe segments which are enmeshed with each other to form a corona-like joint, and a laser system operative to weld the corona-like joint.

### BACKGROUND OF THE DISCLOSURE

### Field of the Disclosure

The disclosure relates to a laser-based system and method for installation of pipelines. In particular, the disclosure relates to a pipe connection system including recessed wall ends of respective adjacent pipe segments which are enmeshed with each other to form a corona-like joint, and a laser system operative to weld the corona-like joint.

### Background Art Discussion

Typically, the laying of the pipeline progresses by the addition of a few-meter long and tens of millimeter thick wall pipe. In many industrial applications, it is common practice to use metallic pipes of a predefined length wall thickness, joined to form a string which reaches oil or gas reservoirs or pools for their extraction. This technique requires gradually casing the inner wall of the well by installing metallic tubes while the well being bored. Once the desired depth is reached, a string of inner metallic pipes of smaller diameter is placed inside the casing, the operation known as tubing. As outer or inner pipe is lowered into the well, its lower end is coupled to the top end of the previously lowered pipe. Typically, the connection is effected by threaded upper and lower flanges attached to respective pipe ends and engaging one another as disclosed immediately below.

The previously lowered pipe is only partially in the bore hole with its threaded female flange extending slightly above the rig floor. The next pipe, which has a threaded male flange, is elevated and held vertically in a derrick with its lowermost end above the female end of the previous pipe. The upper pipe is then lowered with the male threaded flange directed into the female threaded flange so that the threads on the adjacent flanges engage, or, as it is often expressed in the art, the upper pipe is “stabbed” into the lower pipe and further rotated. The alignment of pipes is time-consuming and involves additional tools which all limit string assembling rates and, of course, increase the cost of the pipeline system.

It is therefore a need to improve pipe alignment and pipe connection techniques and assemblies.

### BRIEF SUMMARY OF THE DISCLOSURE

This need is satisfied by the disclosed pipe connection system and method for assembling a pipeline. The disclosed system features a pipe coupling considerably increasing the assembling rate of pipelines in situ.

In accordance with one aspect of the disclosure, the pipe connection system includes opposite ends of the pipes to be joined together to form a pipeline or string. The pipe ends are configured with respective arrangements of circumferentially spaced teeth together defining a corona formation or simply corona. The teeth of opposite coronas of respective consecutive pipes mesh with one another upon bringing the pipes into contact. The corona formation helps the engaging pipes self-center which facilitates the process of assembling the string of pipes.

The teeth of respective engaging pipe ends have a variety of shapes and sizes. In one embodiment, the teeth of coupling pipes interdigitate one another forming a locking coupling. In alternative embodiment, the teeth are interlaced without however being locked.

In still another aspect of the disclosure relates, a method of assembling a string from pipes and/or tubes configured in accordance with any of the above-disclosed aspects is based on the use of laser source in situ. The pipes with smooth ends are delivered to the location of assembling the string. As the pipes sequentially guided into the bore, whether it is casing or tubing string, the ends of the pipes are sequentially laser treated to form respective corona formations. The trailing/subsequent pipe is then lowered to have its teeth mesh with the tooth arrangement of the leading pipe, which is partially stuck out of the bore. Once the enmeshed pipes assume a coaxial position with the teeth of respective coronas fully overlaid, an orbital laser-based welding assembly is activated to weld the engaged pipes along a joint having alternating projections and valleys.

Preferably, a single welding layer is sufficient to provide the desired strength of the weld joint. However, if necessary, several layers can be formed. The method further includes an X-ray camera following a laser welding torch as the joint being welded. In case of several layers, the weld joint may be thus tested as each layer being formed.

### BRIEF DESCRIPTION OF THE DRAWINGS

The above and other features and advantages of the disclosed subject matter will be more readily apparent from the specific description in conjunction with the accompanied drawings, in which:

FIG. 1 illustrates an exemplary block-scheme of the inventive laser based pipe welding system deployed in situ;

FIG. 2 shows the disclosed laser welding assembly for welding vertically positioned pipes;

FIGS. 3A-3C illustrate respective stages of engagement of pipes formed with the disclosed corona configuration;

FIG. 4 illustrates fully enmeshed pipes of FIGS. 3A-3C;

FIGS. 5A-5D illustrate respective modifications of the disclosed corona configuration; and

FIG. 6 in another illustration of the disclosed laser welding assembly.

### SPECIFIC DESCRIPTION

Reference will now be made in detail to the disclosed system. Wherever possible, same or similar reference numerals are used in the drawings and the description to refer to the same or like parts or steps. The word “couple” and similar terms do not necessarily denote direct and immediate connections, but also include connections through intermediate elements or devices. The drawings are in simplified form and are far from precise scale.

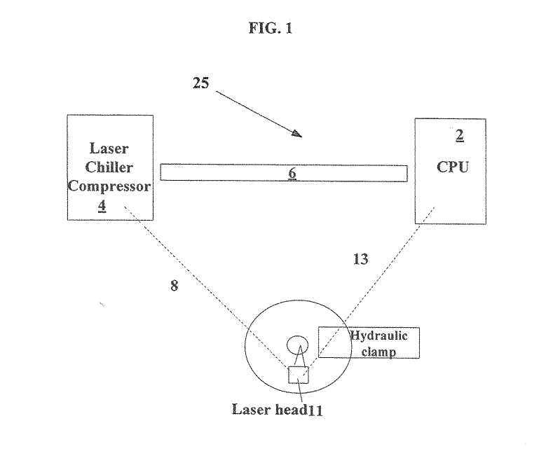

FIG. 1 illustrates in situ exemplary facility provided with a joint welding assembly 25 which includes individual components. In particular, assembly 25 is configured with a central processing unit (CPU) 2 operating to monitor and control a variety of structural elements. For example, a high power fiber or any other type of a laser, chiller and compressor are stored in a closed housing 4. The communication among each of the elements in housing 4 and CPU 2 is realized by means of a flexible cable 6 which carries inside a power cable, air supply conduit and low-current control wires. In case of a fiber laser system, a delivery fiber 8 guides the laser output to a laser head 11, which includes various bulk optics, scanner etc. The displacement of laser head 11 is controlled by CPU 2 outputting control signals which are delivered to the laser head by one or more cables 13. The orbital displacement of laser head 11 around inner or outer periphery of joint pipes along with its displacement along the length of the pipes create a variety of corona-like joint configurations discussed below. A flexible tube 6 encloses a plurality of cables including a power cord, air conduit, intranet cable and the like.

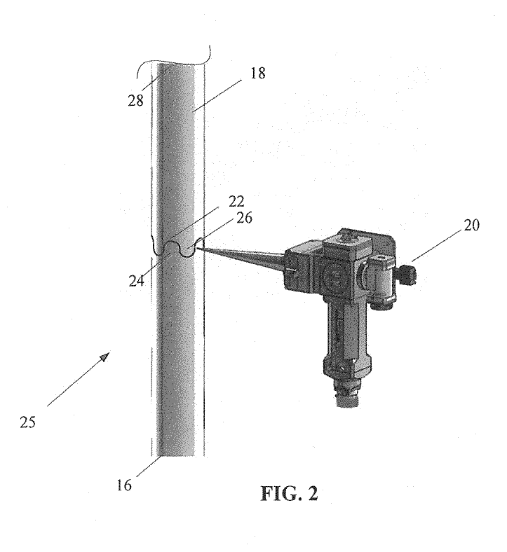

In reference to FIG. 2, system 25 may be deployed without any limitation, to weld water, oil, or natural gas to assemble delivery pipelines. Generally, a pipeline includes welding together each preceding pipe segment 16, lowered for example in a vertical well, with a subsequent pipe segment 18 which is guided into the well until the opposing ends of preceding and subsequent pipes engage one another, as discussed below, defining thus a seam to be laser welded. Assembling the pipeline continues until the desired overall pipeline length is reached.

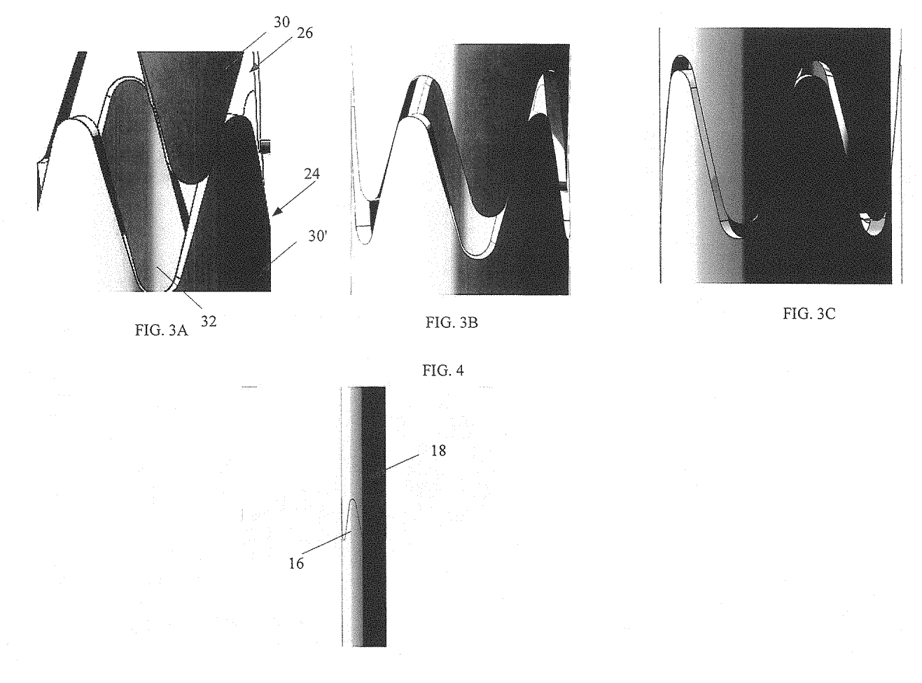

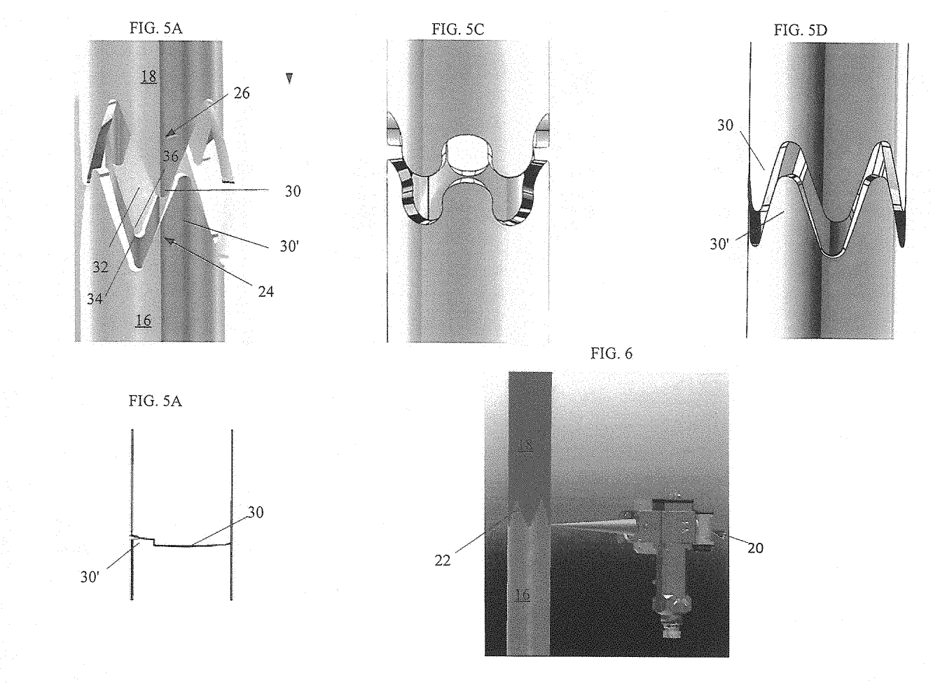

Referring to FIGS. 3A-3C and 4, in accordance with the disclosed concept, the engaging pipe segment ends are formed with respective corona formations 24, 26. As shown in FIG. 3A, formations 24 and 26 have respective arrangements of spaced apart projections or teeth 30 and 30′. Each pair of adjacent teeth defines therebetween a valley or groove 32. The teeth and grooves are configured so that the teeth of one corona formation are gradually guided into respective grooves of the other corona formation.

In the disclosed process, after pipe segment 16 is fixed in the well, a hoisting system lowers subsequent pipe segment 18 toward pipe segment 16 such that teeth 30 of corona 26 each come into sliding contact with respective peripheral edge of tooth 30′, as shown in FIG. 3A. As pipe segment 18 is further guided down, teeth 30 and 30′ gradually move into respective grooves 32 of the engaging pipes through intermediary positions shown in respective FIGS. 3B and 3C. While pipe segments 16 and 18 are engaging one another, subsequent pipe segment 18 gradually self-centers itself under gravity. With teeth 30 and 30′ fully intermeshed, pipe segments 16 and 18 are coaxial which correspond to the engaging position shown in FIG. 4.

Referring to FIGS. 5A-5C, the disclosed corona formation may have a variety of configurations. For example, FIG. 5A illustrates the corona with triangularly shaped teeth 30 and 30′ with the sharp apex. FIG. 5B illustrates a tulip formation. FIG. 5C features teeth 30, 30′ each having an arcuate tip. FIG. 5D illustrates a stepwise formation defined between engaged teeth 30 and 30′ each generally having a rectangular shape.

The engaging teeth and grooves are formed with complementary peripheries. The tightness of fit between the engaging corona formations is controlled by amount of interference. For example, FIG. 5A illustrates shapes and dimensions of meshing teeth which are selected so that the fastening between corona formations 24 and 26 is achieved by friction. In this coupling, when the teeth of corona formation 26 are fully nested in respective grooves of corona formation 24, the pipes are locked relative to one another. However, the locking action is not necessary as exemplified by the embodiments of FIGS. 5B and 5C.

Various configurations allowing the press fit connection are well known to one of ordinary skill in the mechanical arts. For example, as shown in FIG. 5A, groove 32 has a bottom 34 which is slightly greater than a channel 36 providing access to the bottom for the tip of tooth 30 of corona formation 26. The configuration of channel 36 is selected such that the tip of tooth 30 frictionally penetrates channel 36 in response to an external force generated by pipe segment 18 as it is being lowered into the engagement with pipe segment 16. In the engaging position the tip of tooth 36 rests on the bottom of grove 32.

As can be seen in FIGS. 5A-5D, the teeth and grooves each have a cross-section selected from triangular, arcuate and rectangular. It is possible to have a combination of differently shaped formations on each end of the pipes.

FIG. 6 illustrates the final stage of the disclosed process. The joint 22 is welded by a laser beam with a filler, such as wire, being provided to the welding location. One or more laser heads 20 are displaced in the plane of joint 22, and once the welding begins, laser head or heads 20 orbit the joint. As laser head is annularly guided around joint 22, it follows the joint's zig-zag geometry.

The disclosed system and method have several advantages over standard pipeline assembling methods. The disclosed corona coupling assembly does not require a rigid hydraulic clamp system. The rate at which a pipeline assembled is substantially higher than that typical for known prior art methods. The coaxiality of adjacent pipes is obtained as the corona formations engage one another. The corona coupling reduces bending loads on the joint while uniformly distributing these loads over large areas of the pipe walls. The strength of the weld joint produced by the disclosed structure is greater than that of the known prior art methods. For example, the corona weld joint with certain controlled defects was destroyed upon applying a 30-34 ton load. The standard ring weld joint provided with the same defects was destroyed by a 15-20 ton load. The connections must also be capable of withstanding high tensile and compressive loads, the tensile loads being reflected principally in the uppermost connections of the casing, and caused by the weight of the lower portions of the casing, which act upon the connections above them and spaced along the vertical extent of the casing. Additionally, if an obstruction is encountered as the drilling operation proceeds, the connections are often subjected to compressive loads that are imposed on the casing from above in order to assist the drill and casing to penetrate and pass through the obstruction.

The disclosed laser welding process significantly reduces the seam cross section in comparison to conventional welding methods, such as manual arc welding or metal inert gas welding (MIG), and the welding times through application of higher welding rates to thereby improve economic efficiency.

Also, the disclosed laser beam welding can be used to realize good welding results in varying positions including not only the disclosed vertical position, but also horizontal and angular positions, without the need for complex parameter adjustments because the welded seams are characterized in this welding method by a large ratio of depth to width of the seam.

The foregoing description and examples have been set forth merely to illustrate the main concept of the disclosure including coupling pipes by means of the disclosed corona engagement. The disclosed shapes of the corona are merely exemplary and can be easily modified provided however than the main concept of this disclosure is not compromised. Accordingly, disclosure should be construed broadly to include all variation within the scope of the disclosed concept.

1. A method of forming a pipeline, comprising:
sequential delivery a plurality of pipes to a situ, each pipe extending between opposite wall ends each having a corona formation; and
continuously installing pipes in the situ to form a pipeline with a desired pipeline length, the installing including overlaying corona formations of subsequent pipes, thereby producing a joint between adjacent pipes; and
laser welding the joints to provide coupling between the pipes.

2. The method of claim 1, wherein the corona formations are provided before or after the delivery step.

3. The method of claim 1, wherein adjacent pipes are coupled in a vertical, horizontal or angular position.

4. The method of claim 1, further comprising self-centering the adjacent pipes during the engagement of the corona formations.

5. The method of claim 2, wherein the corona formations of respective subsequent pipes lockingly engage one another prior to the welding of the joint.

6. A pipeline assembling system, comprising:
a plurality of pipes each having a longitudinal wall extending between opposite wall ends, each wall end being provided with a corona formation configured such that the corona formations of adjacent pipes mesh one another to form a joint; and
a laser operative to emit laser beam welding the joint.

7. The pipeline assembling system of claim 6, wherein the corona formations of adjacent pipes lockingly engage one another.

8. The pipeline assembling system of claim 6, wherein the corona formation is configured with alternating projections and grooves.

9. The pipeline assembling system of claim 8, wherein the projections and corresponding grooves have respective complementary surfaces.

10. The pipeline assembling systems of claim 8, wherein the projections and grooves each have a cross-section selected from triangular, arcuate and rectangular, and a combination thereof.
